(19) United States
(12) Patent Application Publication
(10) Pub. No.: US 2007/0289164 A1
(43) Pub. Date: Dec. 20, 2007

(54) Footwear having novel shoe upper

(75) Inventors: Pao-Pao Liu, Taichung (TW); Hung-Szu Yuan, Taichung (TW); Ching-Chou Chen, Taoyuan (TW)

Correspondence Address: TROXELL LAW OFFICE PLLC, SUITE 1404, 5205 LEESBURG PIKE, FALLS CHURCH, VA, 22041, US

(73) Assignee: Future Chem International Co., Ltd, Taoyuan (TW)

(21) Appl. No.: 11/454,002

(22) Filed: Jun. 16, 2006

(51) Int. Cl. A43B 23/00; B32B 27/00

(52) U.S. Cl. 36/45; 428/319.3; 428/319.7; 428/317.9; 428/316.6

(57) ABSTRACT

A footwear has a novel shoe upper. The shoe upper is soft and wear-resisting. The making of the shoe upper is simple and the cost is low.

### FIELD OF THE INVENTION

The present invention relates to a footwear; more particularly, relates to obtaining a shoe upper with softness and wear-resist and of low cost.

### DESCRIPTION OF THE RELATED ART

A prior art is claimed in a U.S. patent, U.S. Pat. No. 6,73,9076, “Artificial leather shoe and artificial leather suited therefore”, comprising a shoe upper and a shoe sole. The shoe upper orderly comprises a first substrate layer, an adhesive layer and a second substrate layer. The first substrate layer comprises a first entangled nonwoven fabric and a first elastomeric polymer impregnated in the first entangled nonwoven fabric, where the first entangled nonwoven fabric comprises ultrafine fibers having a fineness of not more than 0.01 decitex. The second substrate layer comprises a second entangled nonwoven fabric and a second elastomeric polymer impregnated in the second entangled nonwoven fabric, where the second entangled nonwoven fabric comprises fibers having a fineness of not less than 0.05 decitex. The outer surface of the first substrate layer forms an exterior surface of the shoe upper. The shoe sole is fixedly bonded to a portion of the shoe upper with an adhesive. At the portion of the shoe upper that is fixedly bonded to the shoe sole, the first substrate layer and the adhesive layer have been substantially removed such that the second substrate layer is directly bonded to the shoe sole with the adhesive. The outer surface of the first substrate layer is at least a partially napped outer surface or is at least partially covered with a macromolecular elastomer. A bond peel strength of the second substrate layer is not less than 7.0 kg/25 cm. A ratio of the bond peel strength of the second substrate layer to a bond peel strength of the first substrate layer is not less than 1.5. In addition, a color difference between the first substrate layer and the adhesive layer, and a color difference between the second substrate layer and the adhesive layer, are both not less than 2.0.

Although the above prior art constructs an artificial leather shoe, the layers of the shoe upper is unstable because they are bond by using adhesive. Besides, the shoe upper used is not soft and is not wear-resisting. Hence, the prior art does not fulfill users' requests on actual use.

### SUMMARY OF THE INVENTION

The main purpose of the present invention is to obtain a shoe upper with softness and wear-resist and of low cost.

To achieve the above purpose, the present invention is a footwear having a novel shoe upper, comprising a shoe sole and a shoe upper on the shoe sole, where the shoe upper comprises a base layer, a blowing layer on the base layer, a shoe-upper layer on the blowing layer, and a cover layer on the shoe-upper layer; the blowing layer is made of a material consisting of a 80 weight percents (wt %) of a Polyolefin Elastomer (POE), a 20 wt % of a Styrene-Ethylene/Butylene-Styrene (SEBS) block copolymer, a 3 parts per hundred of rubber (PHR) of a blowing agent, a 10 PHR of a filler, a 0.4 PHR of a slip agent, and a 0.4 PHR of a blowing additive; and the blowing layer is made of a material consisting of a 20 wt % of a Hydrogenated Styrene-butadiene rubber, a 35 wt % of a SEBS block copolymer, a 15 wt % of a POE, a 30 wt % of a Styrene-Butadiene-Styrene, a 5 PHR of a filler, a 0.3 PHR of an anti-oxidant agent, a 0.3 PHR of an anti-ultraviolet agent and a 0.5 PHR of a slip agent. Accordingly, a novel footwear having a novel shoe upper is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing the preferred embodiment of the present invention;

FIG. 2 is a cross-sectional view showing a partial enlargement of the shoe upper;

FIG. 3 is a view showing the components of a blowing layer;

FIG. 4 is a view showing the components of a shoe-upper layer;

FIG. 5 is a view showing the making of the blowing layer;

FIG. 6 is a view showing the making of the shoe-upper layer; and

FIG. 7 is a view showing the making of the shoe upper.

### DESCRIPTION OF THE PREFERRED EMBODIMENT

The following description of the preferred embodiment is provided to understand the features and the structures of the present invention.

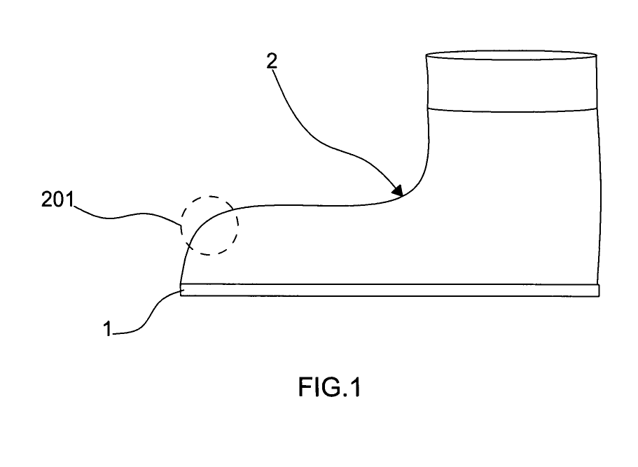

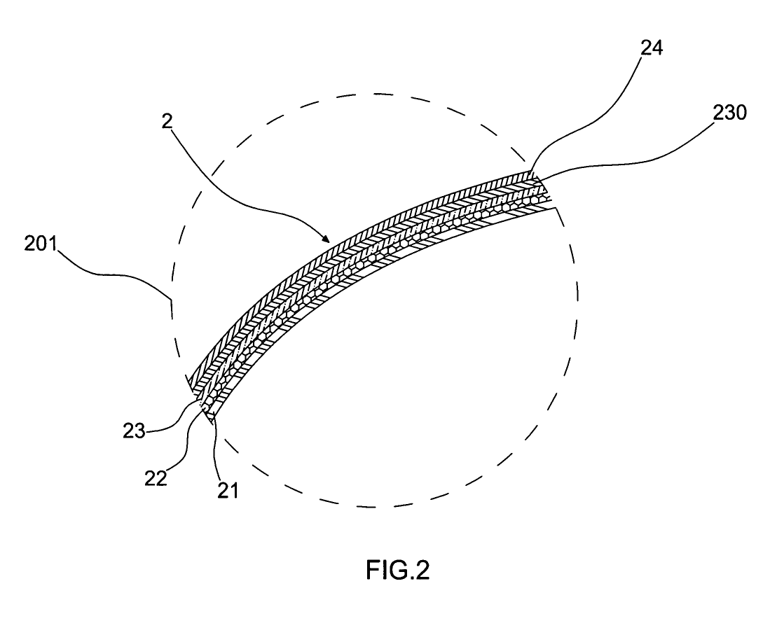

Please refer to FIG. 1, which is a view showing the preferred embodiment of the present invention. As shown in the figure, the present invention is a footwear having a novel shoe upper, comprising a shoe sole [1] and a shoe upper [2] deposed on the shoe sole [1]. Please refer to FIG. 2, which is a cross-sectional view showing a partial enlargement of the shoe upper. As shown in the view of the partial enlargement [201], the shoe upper [2] comprises a base layer [21], a blowing layer [22] deposed on the base layer [21], a shoe-upper layer [23] deposed on the blowing layer [22], and a cover layer [24] covered on the shoe-upper layer [23], where a figure layer [230] is deposed on the shoe-upper layer [23] and the base layer [21] is a fabric. Thus, through the above structure, a novel footwear having a novel shoe upper is obtained.

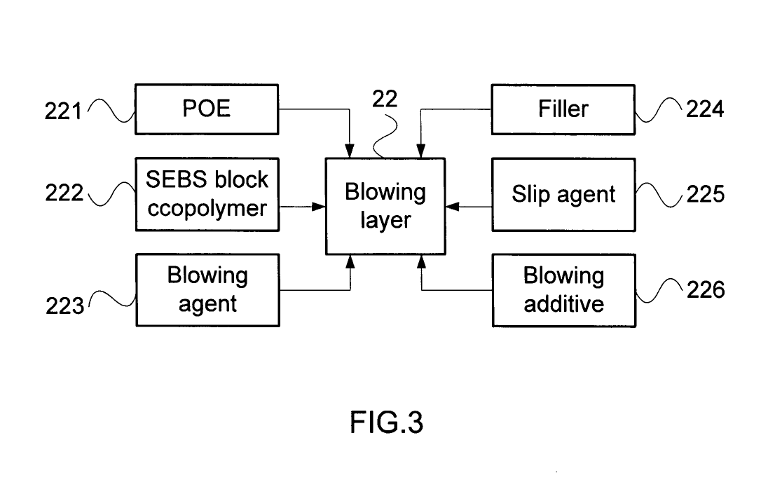

Please refer to FIG. 3, which is a view showing the components of a blowing layer. As shown in the figure, a blowing layer [22] is made of a material obtained by mixing: a) a 80 weight percents (wt %) of a first Polyolefin Elastomer (POE) [221]; b) a 20 wt % of a first Styrene-Ethylene/Butylene-Styrene (SEBS) block copolymer [222]; c) a 3 parts per hundred of rubber (PHR) of a blowing agent [223]; d) a 10 PHR of a first filler [224]; e) a 0.4 PHR of a first slip agent [225]; and f) a 0.4 PHR of a blowing additive [226], where the first POE [221] is made of KEPR 020P; the first SEBS block copolymer [222] is made of Tuftec 020P; the blowing agent [223] is made of AC1000; the first filler [224] is made of CaCO₃; the first slip agent [225] is made of zinc stearate (Zn/St); and the blowing additive [226] is made of zinc oxide (ZnO).

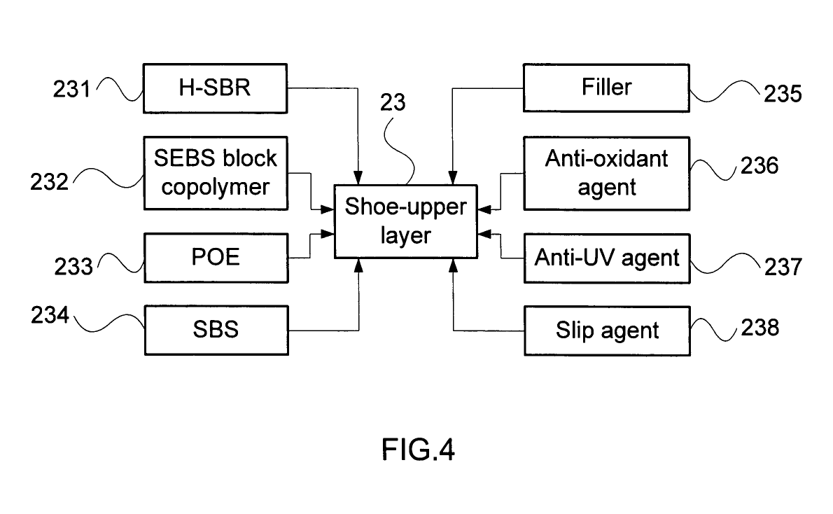

Please refer to FIG. 4, which is a view showing the components of a shoe-upper layer. As shown in the figure, a shoe-upper layer 23 is made of a material obtained by mixing: a) a 20 wt % of a Hydrogenated Styrene-butadiene rubber (H-SBR) [231]; b) a 35 wt % of a second SEBS block copolymer [232]; c) a 15 wt % of a second POE [233]; d) a 30 wt % of a Styrene-Butadiene-Styrene (SBS) [234]; e) a 5 PHR of a second filler [235]; f) a 0.3 PHR of an anti-oxidant agent [236]; g) a 0.3 PHR of an anti-ultraviolet (anti-UV) agent [237]; and h) a 0.5 PHR of a second slip agent [238], where the H-SBR [231] is made of SOE-SS L601; the second SEBS block copolymer [232] is made of Tuftec H1221; the second POE [233] is made of Copp R370Y; the SBS [234] is made of KTR 301; the second filler [235] is made of CaCO₃; the anti-oxidant agent [236] is made of Irganox1010; the anti-UV agent [237] is made of Tinuvin327; and the second slip agent [238] is made of Zn/St.

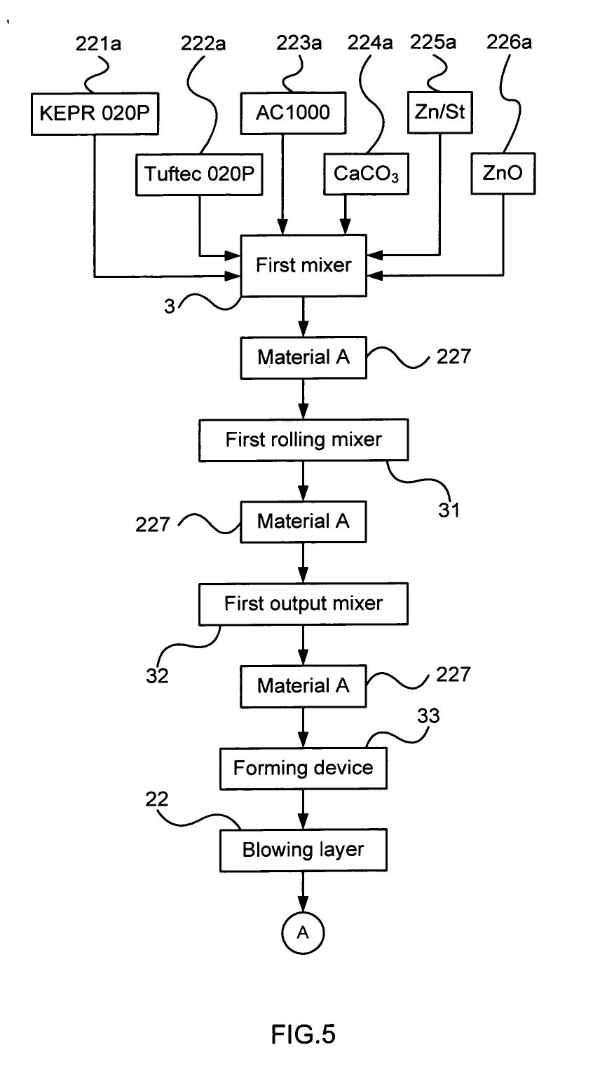

Please refer to FIG. 5, which is a view showing the making of the blowing layer. As shown in the figure, when making the blowing layer [22] as shown in FIG. 3, components for making the blowing layer [22] are mixed in a first mixer [3] under 110 Celsius degrees (° C.) to obtain a Material A [227], where the components include a 80 wt % of KEPR 020P [221a]; a 20 wt % of Tuftec 020P [222a]; a 3 PHR of AC1000 [223a]; a 10 PHR of CaCO₃ [224a]; a 0.4 PHR of Zn/St [225a]; and a 0.4 PHR of ZnO [226a]. Then the Material A [227] is sent to a first rolling mixer [31] to be rolled and pressed. After the rolling and pressing, the Material A [227] is sent by the first output mixer [32] under 150° C.˜170° C. in a speed of 18 meters per minute (m/min) to a forming device [33] to be formed for 1.5˜2 minutes (min) under 220° C. Thus, a blowing layer [22] having a thickness of 0.25 millimeters (mm) is obtained.

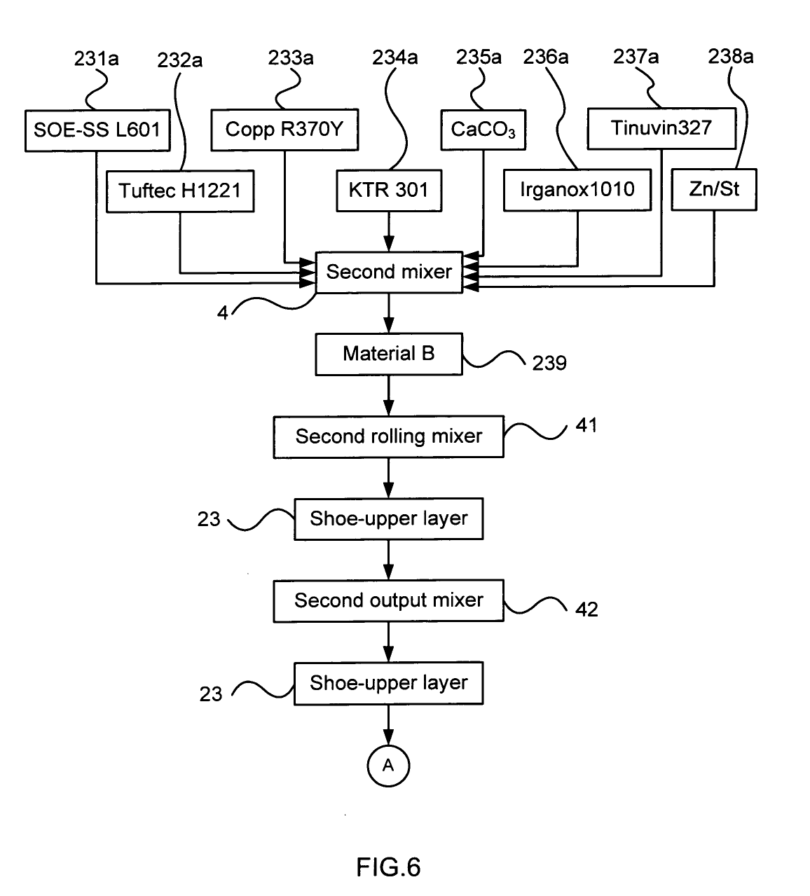

Please refer to FIG. 6, which is a view showing the making of the shoe-upper layer. As shown in the figure, when making the blowing layer [22] as shown in FIG. 3, components for making the shoe-upper layer [23] as shown in FIG. 4 are mixed in a second mixer [4] under 120° C. to obtain a Material B [239], where the components include a 20 wt % of SOE-SS L601 [231 a]; a 35 wt % of Tuftec H1221 [232a]; a 15 wt % of Copp R370Y [233a]; a 30 wt % of KTR 301 [234a]; a 5 PHR of CaCO₃ [235a]; a 0.3 PHR of Irganox1010 [236a]; a 0.3 PHR of Tinuvin327 [237a]; and a 0.5 PHR of Zn/St [238a]. Then the Material B [239] is sent to a second rolling mixer [41] to be rolled and pressed under 155° C.˜160° to obtain a shoe-upper layer [23] having a thickness of 0.13˜0.15 mm. After the rolling and pressing, the shoe-upper layer [23] is sent by the second output mixer [42] under 150° C.˜168° in a speed of 18 m/min. Thus, a shoe-upper layer [23] is obtained.

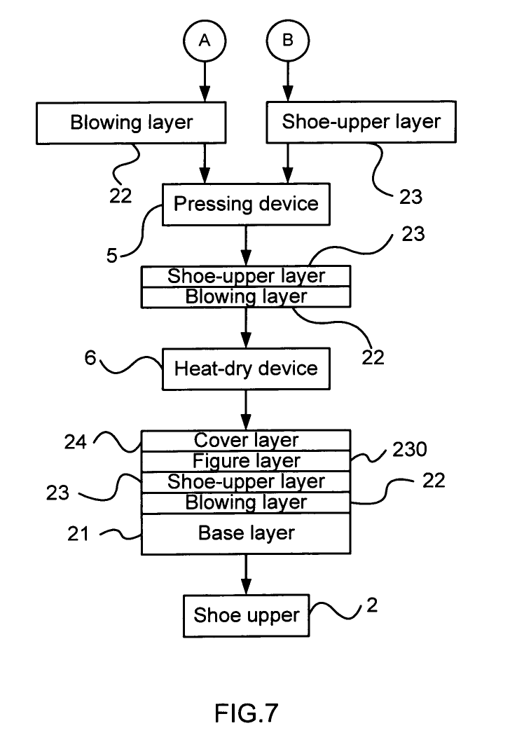

Please refer to FIG. 7, which is a view showing the making of a shoe upper. As shown in the figure, when making the shoe upper [2], the shoe-upper layer [23] made as shown in FIG. 6 and the blowing layer [22] made as shown in FIG. 5 are sent to a pressing device [5] to be fixedly bonded by pressing under 200° C.˜280° C. Then the bonded shoe-upper layer [23] and blowing layer [22] is sent to a heat-dry device [6] for a heat dry. And then the bonded shoe-upper layer [23] and blowing layer [22] is deposed on a base layer [21] having a thickness of 0.45 mm, together with a figure layer [230] deposed on a surface of the shoe-upper layer [23] as required. At last, a cover layer [24] is deposed on the figure layer [230]. Thus, a shoe upper [2] of the present invention having a thickness of 0.9˜0.95 mm is obtained.

To sum up, the present invention is a footwear having a novel shoe upper, where the footwear is thus of low cost and the shoe upper is soft and wear-resisting.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A footwear having a novel shoe upper, comprising:
a shoe sole; and
a shoe upper deposed on said shoe sole,
wherein said shoe upper comprises
(a) a base layer;
(b) a blowing layer deposed on said base layer;
(c) a shoe-upper layer deposed on said blowing layer; and
(d) a cover layer deposed on said shoe-upper layer;
wherein said blowing layer is made of a material obtained by mixing
(a) a 80 weight percents (wt %) of a first Polyolefin Elastomer (POE);
(b) a 20 wt % of a first Styrene-Ethylene/Butylene-Styrene (SEBS) block copolymer;
(c) a 3 parts per hundred of rubber (PHR) of a blowing agent;
(d) a 10 PHR of a first filler;
(e) a 0.4 PHR of a first slip agent; and
(f) a 0.4 PHR of a blowing additive; and
wherein said shoe-up per layer is made of a material obtained by mixing
(a) a 20 wt % of a Hydrogenated Styrene-butadiene rubber (H-SBR);
(b) a 35 wt % of a second SEBS block copolymer;
(c) a 15 wt % of a second POE;
(d) a 30 wt % of a Styrene-Butadiene-Styrene (SBS);
(e) a 5 PHR of a second filler;
(f) a 0.3 PHR of an anti-oxidant agent;
(g) a 0.3 PHR of an anti-ultraviolet (anti-UV) agent; and
(h) a 0.5 PHR of a second slip agent.

2. The footwear according to claim 1,
wherein said base layer is a fabric.

3. The footwear according to claim 1,
wherein said first POE of said blowing layer is made of KEPR 020P.

4. The footwear according to claim 1,
wherein said first SEBS block copolymer of said blowing layer is made of Tuftec 020P.

5. The footwear according to claim 1,
wherein said blowing agent of said blowing layer is made of AC1000.

6. The footwear according to claim 1,
wherein said first filler of said blowing layer is made of calcium carbonate (CaCO₃).

7. The footwear according to claim 1,
wherein said first slip agent of said blowing layer is made of zinc stearate (Zn/St).

8. The footwear according to claim 1,
wherein said blowing additive of said blowing layer is made of zinc oxide (ZnO).

9. The footwear according to claim 1,
wherein said H-SBR of said shoe-upper layer is made of SOE-SS L601.

10. The footwear according to claim 1,
wherein said second SEBS block copolymer of said shoe-upper layer is made of Tuftec H1221.

11. The footwear according to claim 1,
wherein said second POE of said shoe-upper layer is made of Copp R370Y.

12. The footwear according to claim 1,
wherein said SBS of said shoe-upper layer is made of KTR 301.

13. The footwear according to claim 1,
wherein said second filler of said shoe-upper layer is made of calcium carbonate (CaCO₃).

14. The footwear according to claim 1,
wherein said anti-oxidant agent of said shoe-upper layer is made of Irganox1010.

15. The footwear according to claim 1,
wherein said anti-UV agent of said shoe-upper layer is made of Tinuvin327.

16. The footwear according to claim 1,
wherein said second slip agent of said shoe-upper layer is made of Zn/St.

17. The footwear according to claim 1,
wherein a figure layer is deposed on a surface of said shoe-upper layer corresponding to said cover layer.
